(19) United States
(12) Patent Application Publication
(10) Pub. No.: US 2024/0238787 A1
(43) Pub. Date: Jul. 18, 2024

(54) PLATE ASSAY DEVICE AND METHOD FOR IN SITU IMAGING

(71) Applicant: Duke University, Durham, NC (US)

(72) Inventors: Akhenaton-Andrew Jones, Durham, NC (US); Sarah Kate Childs, Durham, NC (US)

(21) Appl. No.: 18/411,564

(22) Filed: Jan. 12, 2024

Related U.S. Application Data
(60) Provisional application No. 63/438,666, filed on Jan. 12, 2023.

(51) Int. Cl. B01L 3/00

(52) U.S. Cl. CPC B01L 3/50853; B01L 2300/041; B01L 2300/0829; B01L 2300/0848

(57) ABSTRACT

A lid for an assay. The lid including a peg coupled to the lid. The peg including a first end coupled to the lid, a second end opposite the first end, a longitudinal axis that extends between the first end and the second end, a first portion extending from the first end towards the second end and having a first outer dimension, a second portion extending from the second end towards the first end and having a second outer dimension, and a third portion positioned between the first portion and the second portion, the third portion having a third outer dimension that is smaller than the first outer dimension and greater than the second outer dimension, a surface of the third portion defining a step between the first end and the second end.

### CROSS-REFERENCE TO RELATED APPLICATIONS

This application claims priority to co-pending U.S. Provisional Patent Application No. 63/438,666, filed on Jan. 12, 2023, the entire contents of which are incorporated herein by reference.

### STATEMENT REGARDING FEDERALLY SPONSORED RESEARCH OR DEVELOPMENT

This invention was made with government support under R35 GM142898 awarded by the National Institutes of Health National Institute of General Medical Sciences (NIH/NIGMS). The government has certain rights in the invention.

### FIELD OF THE DISCLOSURE

The present disclosure relates to a microfluid assay including a lid with a plurality of pegs and a base that is couplable to the lid.

### BACKGROUND

The world is headed towards an antibacterial resistance cliff, a point where common medical procedures will risk deadly infections, expected to occur between 2030 and 2050, with failure to address this crisis estimated to cost over $1 trillion annually. Bacteria primarily exist in biofilms, grouped together in a matrix of polymers, sugars, proteins, and extracellular DNA, which both reduce the efficacy of antibiotics and enable increased antimicrobial resistance gene transfer. While there has been a promising shift in scientific focus from strategies targeting planktonic bacteria to bacterial biofilms, standardized in situ tools for imaging biofilms are still lacking.

Microfluidic assays to study bacterial biofilms are commonly used but are limited in throughput and have been difficult to standardize. Microfluidic assays have allowed for facile visualization with fluorescent microscopes enabling in situ understandings of biofilm development and dispersal. Microfluidic assays are easy to produce and customize. ASTM International standardized methods for biofilm research and other proposed biofilm research protocols are notably repeatable, fast, and reliant on accessible supplies like coupons and conical tubes or a combination. Moreover, there are four ASTM International-approved standardized devices for studying biofilms: the CDC biofilm reactor, a drip flow reactor, a rotating disk reactor, and the MBEC Assay® or similar peg lid microtiter plate assays all with limited in situ microscopy access. The MBEC Assay® is a 96-well plate lid with pegs that sit in the wells.

Microtiter biofilm assays can be used to quantify biofilm growth to assess antibiotic or disinfectant susceptibility with many methods including crystal violet staining, microscopy, or live cell counts. For example, Pseudomonas aeruginosa (i.e., P. aeruginosa) biofilm metabolic activity in the presence of multiple antibiotic concentrations and combinations was rapidly screened for in a high-throughput 384-well plate device using automated, single focal plane microscopy and image analysis. Protocols have recently been proposed to use confocal microscopy and plate readers to analyze antibiotic susceptibility using medium throughput 96-well plate in ˜60 h and 4-5 days respectively. Finally, the Fluxion Bioflux device tries to merge the visualization capabilities of microfluidics with the speed of medium throughput devices by introducing a microfluidic system between wells of a 24 or 96 well plate platform, to varying degrees of success.

Two limitations of the microtiter biofilm assay addressed by the MBEC Assay® include high variation between wells and settled planktonic cells erroneously counted as biofilm. The MBEC Assay® produces similar biofilms across the 96 pegs and restricts biofilm bacteria to those cells actively attaching to or growing on the pegs. The MBEC Assay® is used to establish biofilms and challenge those biofilms with an antimicrobial or disinfectant enabling measurement of a minimum biofilm eradication concentration similar to a planktonic culture's minimum inhibitory concentration.

However, the peg lid microtiter plate assay limits the ability to image the biofilm in situ. The primary manufacturer of the peg lids and other protocols suggest using pliers to break off pegs for imaging and other tests which is difficult to do without disrupting or contaminating the pegs. The lack of in situ optical access also significantly increases the time and materials necessary to analyze the biofilms. Furthermore, successful images of biofilms formed on the MBEC Assay® are generally flat and lack complex formations seen in other in situ assays such as microfluidic cells.

Accordingly, additional studies and solutions are desirable to enable in situ imaging of complex biofilm features while maintaining the throughput features of the original assay.

### SUMMARY OF THE DISCLOSURE

Microtiter plate assay lid peg designs as disclosed herein differ from traditional pegs by altering working distance, surface area, and edges. These modifications also allow for changes in the structure of the biofilm to be monitored over longer periods of time and with additional details that could not be measured with a standard assay, while maintaining an easy to set up, high-throughput design. Confocal laser scanning microscopy (CLSM) is a versatile tool for studying biofilms but requires innovative solutions to obtain high-quality results.

The present disclosure provides multiple peg geometries for the lid microtiter plate assay and their capacity to be imaged under confocal microscopy. In addition, the present disclosure provides a geometry-optimized peg for biofilm imaging under confocal microscopy that maintains the throughput features of the original assay while showing results that previously were only accessible in microfluidic devices. Improvements to the geometry and texture of the peg allow for a more dynamic visualization in the well plate by preserving delicate structures within a biofilm and allowing more pegs to be viewed.

The present disclosure also provides a method of executing an assay (e.g., via CLSM) using one or more embodiments of the disclosed device.

In some aspects, the techniques described herein relate to a lid for an assay including: a peg coupled to and extending from the lid, the peg including a first end coupled to the lid, a second end opposite the first end, a longitudinal axis extending between the first end and the second end, a first portion extending from the first end towards the second end, the first portion having a first surface that extends along the longitudinal axis and that has a first outer dimension and a second surface that extends inwardly from the first surface towards the longitudinal axis; a second portion positioned between the first portion and the second end, the second portion having a third surface that extends along the longitudinal axis and that has a second outer dimension that is less than the first outer dimension and a fourth surface that extends inwardly from the third surface towards the longitudinal axis; and a third portion extending from the second end towards the first end, the third portion having a fifth surface that extends along the longitudinal axis and that has a third outer dimension that is less than the second outer dimension and a sixth surface that extends inwardly from the fifth surface towards the longitudinal axis.

In some aspects, the techniques described herein relate to a lid for an assay including: a peg coupled to the lid, the peg including a first end coupled to the lid, a second end opposite the first end, a longitudinal axis that extends between the first end and the second end, a first portion extending from the first end towards the second end and having a first outer dimension, a second portion extending from the second end towards the first end and having a second outer dimension, and a third portion positioned between the first portion and the second portion, the third portion having a third outer dimension that is smaller than the first outer dimension and greater than the second outer dimension, a surface of the third portion defining a step between the first end and the second end.

In some aspects, the techniques described herein relate to a device to conduct an assay, the device including: a base; and a lid that is couplable to the base, the lid including an inner wall; and a plurality of pegs coupled to inner wall, each of the pegs including a first end coupled to the wall, a second end opposite the first end, a longitudinal axis extending between the first wall and the second wall, a non-stepped portion extending from the first end towards the second end, and a stepped portion extending from the second end to the non-stepped portion, wherein when the lid is coupled to the base, the plurality of pegs is positioned within the base.

### BRIEF DESCRIPTION OF THE DRAWINGS

FIG. 1 is a perspective view of a lid for an assay according to an embodiment of the present disclosure.

FIG. 2 is a side view of a peg on the lid of FIG. 1.

FIG. 3 is a perspective view of the peg of FIG. 2.

FIG. 4 is a perspective view of the lid of FIG. 1 coupled to a base.

FIG. 5 is schematic view of the peg of FIGS. 2-3 with a biofilm on a portion thereof.

FIG. 6 is a diagram that shows an antibiotic challenge experimental process using the lid of FIG. 1.

FIG. 7A shows the raw data and mean difference versus no antibiotics for 100 μg/mL tetracycline, 10 μg/mL tetracycline on an OD 600 basis on a MBEC® Assay for PA14.

FIG. 7B shows the raw data and mean difference versus no antibiotics for 100 μg/mL tetracycline, 10 μg/mL tetracycline on an OD 600 basis on the lid of FIG. 1 for PA14.

FIG. 7C shows the raw data and mean difference versus no antibiotics for 100 μg/mL tetracycline, 10 μg/mL tetracycline on an OD 600 basis on a CFU/mm2 for PA14.

FIG. 7D shows equivalent biofilm test using OD 600 readings of biofilm recovered in PBS by sonication from one of the pegs of the lid of FIG. 1.

FIG. 8A shows an area imaged at a second end of the peg of FIGS. 2-3.

FIG. 8B shows selected 3D tiles of the surface of the second end of FIG. 8A.

FIG. 8C shows the surface biomass on the second end of FIG. 8A analyzed using COMSTAT 2.1 was plotted using EstimationStats.

FIG. 8D shows an area imaged in at a second end and a step of the peg of FIGS. 2-3.

FIG. 8E shows selected Z-stacks of the space between the step and the second end of FIG. 8D.

FIG. 8F shows the biomass on the step of FIG. 8D analyzed using COMSTAT 2.1 was plotted using EstimationStats.

FIG. 9A shows an example of a challenge plate layout including three concentrations of antibiotic (100 μg/mL tetracycline, 10 μg/mL tetracycline, and no antibiotic), two uninoculated controls are included as BC (broth control, no peg) and PC (peg control), checking for media and device sterility, respectively.

FIG. 9B shows a layout of equivalent biofilm test plate. The wells enclosed in a solid line include TSB and PA14. P indicates the peg control well and B indicates the broth control well. Pegs on the dashed line are outside pegs and pegs on the dash dot line inside pegs.

FIG. 10 illustrates a test lid having pegs with six different geometries, one row of the pegs having the geometry of the peg of FIG. 1.

FIG. 11 is a diagram that shows an experimental process using the test lid of FIG. 10.

FIG. 12A illustrates biofilm forming on the sides of the conventional peg. The black box indicates the approximate section that can be imaged using the conventional peg shape.

FIG. 12B illustrates a Z stack of a 96 well conventional peg lid growing E. coli S17-1 lambda pir.

FIG. 12C illustrates a single slice from the Z stack of FIG. 12B growing E. coli S17-1 lambda pir.

FIG. 12D illustrates a Z stack of a 96 well conventional peg lid a growing P. aeruginosa PA14.

FIG. 12E illustrates a single slice from the Z stack of FIG. 12D growing P. aeruginosa PA14.

FIG. 13A illustrates a peg of the lid of FIG. 1.

FIG. 13B illustrates a tile of the bottom of the peg of FIG. 13A growing E. coli S17-1 lambda pir.

FIG. 13C illustrates a tile of the bottom of the peg of FIG. 13A growing P. aeruginosa PA14.

FIG. 14A illustrates a hemisphere peg.

FIG. 14B illustrates a tile of the bottom of the peg of FIG. 14A growing E. coli S17-1 lambda pir.

FIG. 14C illustrates a tile of the bottom of the peg of FIG. 14A growing P. aeruginosa PA14.

FIG. 15A illustrates a square peg.

FIG. 15B illustrates a tile of the bottom of the peg of FIG. 15A growing E. coli S17-1 lambda pir.

FIG. 15C illustrates a tile of the bottom of the peg of FIG. 15A growing P. aeruginosa PA14.

FIG. 16A illustrates a cone peg.

FIG. 16B illustrates a tile of the bottom of the peg of FIG. 16A growing E. coli S17-1 lambda pir.

FIG. 16C illustrates a tile of the bottom of the peg of FIG. 16A growing P. aeruginosa PA14.

FIG. 17A illustrates a first cylinder peg.

FIG. 17B illustrates a tile of the bottom of the peg of FIG. 17A growing E. coli S17-1 lambda pir.

FIG. 17C illustrates a tile of the bottom of the peg of FIG. 17A growing P. aeruginosa PA14.

FIG. 18A illustrates a second cylinder peg.

FIG. 18B illustrates a tile of the bottom of the peg of FIG. 18A growing E. coli S17-1 lambda pir.

FIG. 18C illustrates a tile of the bottom of the peg of FIG. 18A growing P. aeruginosa PA14.

FIG. 19 illustrates excessive biomass from biofilm streamers of the peg of FIG. 13A causing a “shadow” to be cast on the autofluorescing disk.

FIG. 20A illustrates a CFU count of detached biofilm suspended in PBS of the pegs of the test lid of FIG. 10.

FIG. 20B illustrates an OD 600 reading of detached biofilm suspended in PBS of the pegs of the test lid of FIG. 10.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Articles “a” and “an” are used herein to refer to one or to more than one (i.e., at least one) of the grammatical object of the article. By way of example, “an element” means at least one element and can include more than one element.

“About” is used to provide flexibility to a numerical range endpoint by providing that a given value may be “slightly above” or “slightly below” the endpoint without affecting the desired result.

The use herein of the terms “including,” “comprising,” or “having,” and variations thereof, is meant to encompass the elements listed thereafter and equivalents thereof as well as additional elements. As used herein, “and/or” refers to and encompasses any and all possible combinations of one or more of the associated listed items, as well as the lack of combinations where interpreted in the alternative (“or”).

As used herein, the transitional phrase “consisting essentially of” (and grammatical variants) is to be interpreted as encompassing the recited materials or steps “and those that do not materially affect the basic and novel characteristic(s)” of the claimed invention. Thus, the term “consisting essentially of” as used herein should not be interpreted as equivalent to “comprising.”

Moreover, the present disclosure also contemplates that in some embodiments, any feature or combination of features set forth herein can be excluded or omitted. To illustrate, if the specification states that a complex comprises components A, B and C, it is specifically intended that any of A, B or C, or a combination thereof, can be omitted and disclaimed singularly or in any combination.

Recitation of ranges of values herein are merely intended to serve as a shorthand method of referring individually to each separate value falling within the range, unless otherwise indicated herein, and each separate value is incorporated into the specification as if it were individually recited herein. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this disclosure.

Unless otherwise defined, all technical terms used herein have the same meaning as commonly understood by one of ordinary skill in the art to which this disclosure belongs.

The systems described herein can be implemented in hardware, software, firmware, or combinations of hardware, software and/or firmware. In some examples, the systems described in this specification may be implemented using a non-transitory computer readable medium storing computer executable instructions that when executed by one or more processors of a computer cause the computer to perform operations. Computer readable media suitable for implementing the systems described in this specification include non-transitory computer-readable media, such as disk memory devices, chip memory devices, programmable logic devices, random access memory (RAM), read only memory (ROM), optical read/write memory, cache memory, magnetic read/write memory, flash memory, and application-specific integrated circuits. In addition, a computer readable medium that implements a system described in this specification may be located on a single device or computing platform or may be distributed across multiple devices or computing platforms.

One skilled in the art will readily appreciate that the present disclosure is well adapted to carry out the objects and obtain the ends and advantages mentioned, as well as those inherent therein. The present disclosure described herein are presently representative of preferred embodiments, are exemplary, and are not intended as limitations on the scope of the present disclosure. Changes therein and other uses will occur to those skilled in the art which are encompassed within the spirit of the present disclosure as defined by the scope of the claims.

No admission is made that any reference, including any non-patent or patent document cited in this specification, constitutes prior art. In particular, it will be understood that, unless otherwise stated, reference to any document herein does not constitute an admission that any of these documents forms part of the common general knowledge in the art in the United States or in any other country. Any discussion of the references states what their authors assert, and the applicant reserves the right to challenge the accuracy and pertinence of any of the documents cited herein. All references cited herein are fully incorporated by reference, unless explicitly indicated otherwise. The present disclosure shall control in the event there are any disparities between any definitions and/or description found in the cited references.

The following examples are provided by way of illustration and not by way of limitation.

Biofilms are quantified and observed using a variety of methods, such as, crystal violet staining, optical density after detachment, scanning electron microscopy (SEM), and confocal laser scanning microscopy (CLSM), depending on the type of experiment, resources available, and a balance of the advantages and drawbacks of the method. CLSM allows researchers to observe the inner workings and development of living cells in 3D over time with limitations such as choosing the best fluorescent tag and working distance, which can be problematic for inverted units. Choosing an experimental setup for CLSM is particularly important as each comes with a unique set of advantages and challenges that can either improve or limit what data can be collected.

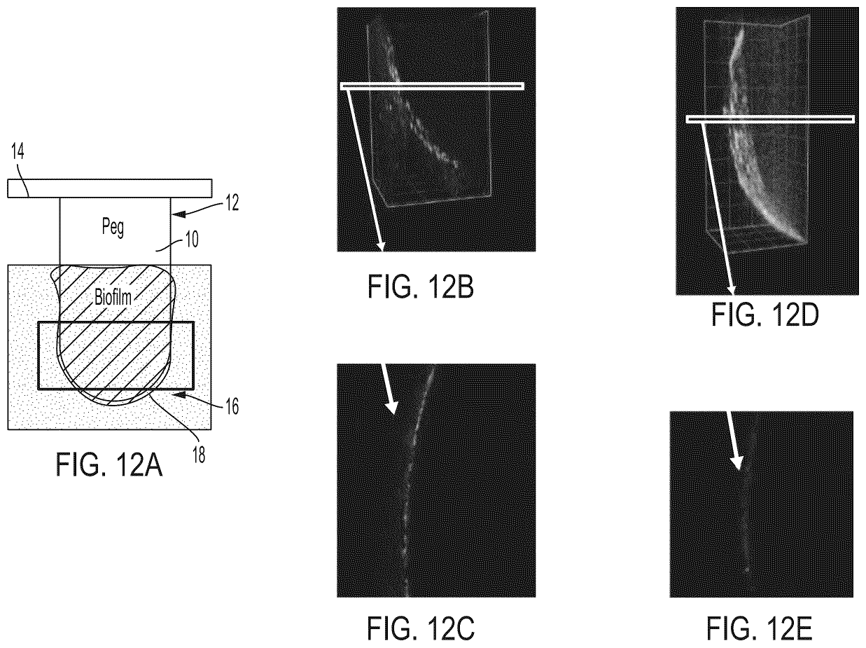

As noted above, the MBEC Assay® is a 96-well plate lid with pegs 10 that sit in the wells. An exemplary conventional peg 10 is shown in FIG. 12A. Conventional pegs 10 of the MBEC Assay® have a first end 12 coupled to an inner wall 14 of the lid and a second end 16 with an arcuate surface 18.

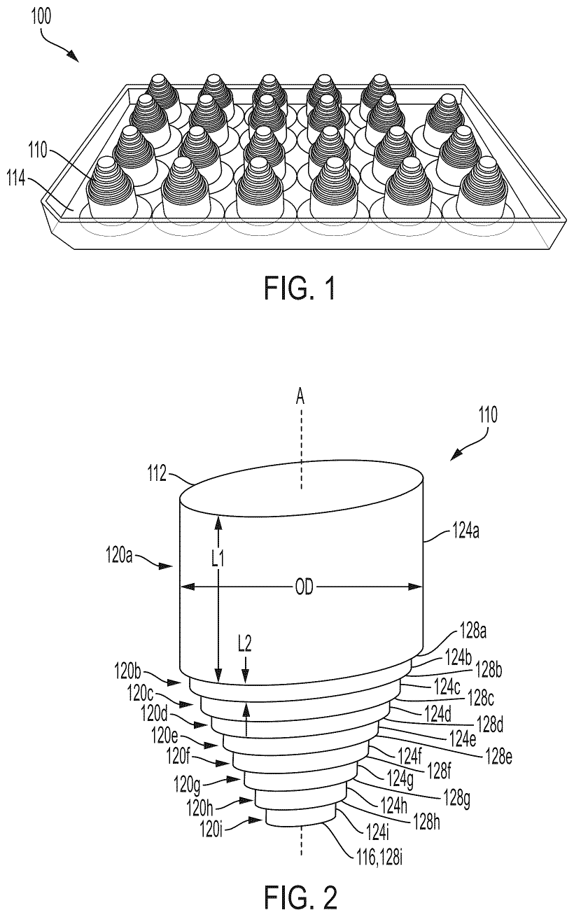

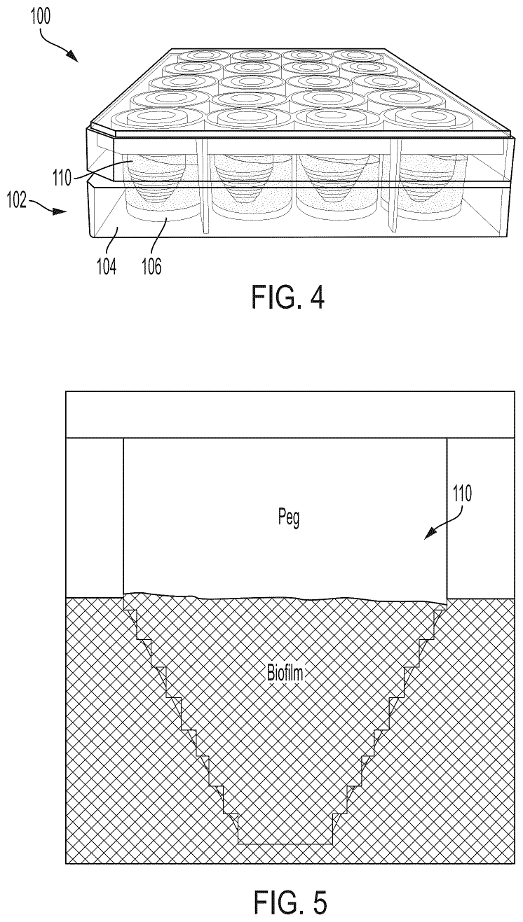

FIG. 1 illustrates a perspective view of a lid 100 of a microfluidic assay 102 (FIG. 4) including pegs 110 with a ziggurat inspired cone. As shown, the lid 100 includes an inner wall 114 and a plurality of pegs 110 extending from the inner wall 114. The assay 102 includes a base 104 to which the lid 100 is coupleable. In the illustrated embodiment, the base 104 includes a plurality of individual wells 106, each of which receives a peg 110 when the lid 100 is coupled to the base 104. In other embodiments, the base 104 may include a trough that receives the pegs 110.

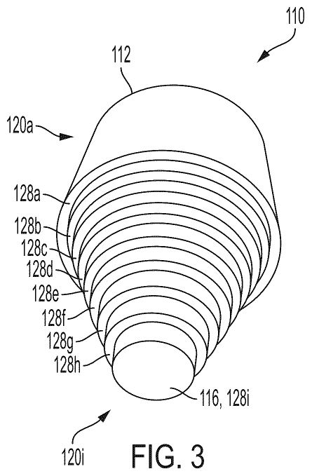

As shown in FIGS. 2-3, each of the pegs 110 has a first end 112 that is coupled to the inner wall 114, a second end 116 that is opposite the first end 112, and a longitudinal axis A extending between the first end 112 and the second end 116. As shown, each peg 110 generally includes a plurality of portions 120a-120i. Each portion includes a first surface 124a-124i that extends along the longitudinal axis A and a second surface 128a-128i that extends inwardly from the first surface 124a-124i towards the longitudinal axis A. In the illustrated embodiment, the second wall 128a-128i is generally transverse (e.g., perpendicular) to the longitudinal axis A and generally parallel to the inner wall 114 of the lid 100. The first surface 124a-124i defines an outer dimension OD. The outer dimension OD of each portion 120a-120i is different. The first surface 124a of the proximal-most portion 120a is coupled to and extends from the inner wall 114 of the lid 100. The second surface 128i of the distal-most portion 120i defines the second end 116. In the illustrated embodiment, there are nine portions 120a-120i, but in other or additional embodiments, there may be more or fewer portions.

In the illustrated embodiment, the proximal-most portion 120a has a first length L1 between the first end 112 and its second surface 128a. Also, the outer dimension OD is uniform along the first length L1. In the illustrated embodiment, the outer dimension OD of the proximal-most portion 120a is 11.2 mm, but in other embodiments, the outer dimension OD of the proximal-most portion 120a may range from 2.6 mm to 11.2 mm. The proximal-most portion 120a may be considered a non-stepped portion of the peg 110 because the outer dimension thereof is constant and therefore does not have steps along the first length L1. In the illustrated embodiment, the first length L1 is 8.5 mm, but in other embodiments, the first length L1 may range from 2 mm to 9 mm.

The other portions 120b-120i each define a second length L2 between the second surface 128a-128h of the adjacent portion 120a-120h and its own second surface 128b-128i. The second length L2 is less than the first length L1. In the illustrated embodiment, the second length L2 is 1 mm, but in other embodiments, the second length L2 may range from 0.1 mm to 1 mm. Also, moving from the proximal-most portion 120a towards the second end 116, each consecutive portion of the remaining portions 120b-120i has an outer dimension OD that is less than the outer dimension OD of the previous portion. In the illustrated embodiment, the outer dimension OD of each consecutive portion 120b-120i is 92% that of the outer dimension OD of the previous portion 120a-120h. For example, as noted above, the outer dimension OD of the proximal-most portion 120a is 11.2 mm, while the outer dimension OD of the adjacent portion 120b is 10.2 mm, such that the outer dimension OD of the portion 120b is 92% of the outer dimension OD of the proximal-most portion 120a. In other embodiments, the percentage may range from 75% to 92%. In the illustrated embodiment, there are eight of the portions 120b-120i extending from the proximal-most portion 120a. However, in other embodiments, there may be more or fewer portions that extend from the proximal-most portion 120a.

In one example, the proximal-most portion 120a may be a first portion having a first surface 124a and a second surface 128a. The first surface 124a extends along the longitudinal axis A and has a first outer dimension OD. The second surface 128a extends inwardly from the first surface 124a towards the longitudinal axis A. One of the other portions 120b-120h may be a second portion positioned between the first portion 120a and the second end 116. The second portion 120b-120h has a third surface 124b-124h and a fourth surface 128b-128h. The third surface 124b-124h extends along the longitudinal axis A and has a second outer dimension OD that is less than the first outer dimension OD of the first portion 120a. The fourth surface 128b-128h extends inwardly from the third surface 120b-120h towards the longitudinal axis A. Another of the other portions may be a third portion (e.g., the distal-most portion 120i) extending from the second end 116 towards the first end 112. The third portion 120i has a fifth surface 124i and a sixth surface 128i. The fifth surface 124i extends along the longitudinal axis A and has a third outer dimension OD that is less than the second outer dimension OD of the second portion 120b-120h. The sixth surface 128i extends inwardly from the fifth surface 124i towards the longitudinal axis A. In this case, the sixth surface 128i is at the second end 116. In such case, the second surface 128a and the fourth surface 128b-128h serve as steps between the first end 112 and the second end 116. In another example, a fourth portion 120b-120h may extend between the first portion 120a and the second portion 120b-120h. In such case, the fourth portion has a seventh surface 124b-124h and an eighth surface 128b-128h. The seventh surface 124b-124h extends along the longitudinal axis A and that has a fourth outer dimension OD that is less than the first outer dimension OD and greater than the second outer dimension OD. The eighth surface 128b-128h extends inwardly from the seventh surface 124b-124i towards the longitudinal axis A. Accordingly, the second surface 128a, the eighth surface 128b-128h, and the fourth surface 128b-128h serve as steps. Again, in the illustrated embodiment there are nine portions 120a-120i. Therefore, there are seven portions 120b-120h that are positioned between the first portion (e.g., the proximal-most portion 120a) and the third portion (e.g., the distal-most portion 120i), each having a surface 128a-128h that serves as a step. The second portion and the fourth portion are two of those seven portions. In other or additional embodiments, there may be more or fewer than seven portions between the first portion and the third portion.

State another way, in the illustrated embodiment, there are eight portions 120b-120i extending from the first portion (e.g., the proximal-most portion 120a). As shown, there are seven portions 120b-120h extending between the first portion (e.g., the proximal-most portion 120a) and a second portion (e.g., the distal-most portion 120i). Therefore, in the illustrated embodiment, there are eight steps between the first end 112 and the second end 116. That is, the second surface 128a-128h of each of the first portion 120a and the other seven portions 120b-120h create steps. As noted above, the peg 110 may be greater or fewer portions 120a-120h such that there are greater or fewer steps. Regardless of the specific number, as shown, a subset of the plurality of portions 120b-120i may collectively define a stepped portion of the peg 110 because the consecutive portions each have a shorter second length L2 and an increasingly smaller outer dimensions OD. Moreover, as shown, in the illustrated embodiment, the subset of plurality of portions 120b-120i (e.g., the stepped portion) collectively define a ziggurat shape.

In the illustrated embodiment, each of the plurality of portions 120a-120i defines a substantially cylindrical shape and therefore the cross-section of each defines a circular shape such that the outer dimension OD is the diameter thereof. Accordingly, each of the plurality of portions 120a-120i is concentric with one another. In other embodiments, the plurality of portions 120a-120i may have other shapes. Moreover, each of the plurality of portions 120a-120i has the same shape. In other embodiments, each of the plurality of portions 120a-120i may have a different shape or some of the plurality of portions 120a-120i may have a first shape while others of the plurality of portions 120a-120i have a second, different shape. Additionally, while consecutive steps are separated by the same distance (e.g., L2) in the illustrated embodiment, they may be separated by different distances in other embodiments.

In the illustrated embodiment, the first surface 124a-124i and the second surface 128a-128i of each of the portions 120a-120i are generally transverse to one another. As shown, the first surface 124a-124i and the second surface 128a-128i of each of the portions 120a-120i are generally perpendicular to one another. In other embodiments, the first surface 124a-124i and the second surface 128a-128i of each of the portions 120a-120i may be positioned at other non-parallel and non-perpendicular angles relative to one another. Additionally, the cylindrical shape of the portions 120a-120i creates second surfaces 128a-128h (e.g., steps) that are substantially flat. Therefore, each of the second surfaces 128a-128h that create the steps are generally transverse to the longitudinal axis A and parallel to the inner wall 114. In other embodiments, the second surfaces 128a-128i may not be flat. For example, the second surfaces 128a-128i may have an arcuate, sinusoidal (e.g., scalloped), or any suitable shape. In some embodiments, the surfaces 128a-128i of the stepped portion may be smooth. In other embodiments, the surfaces 128a-128i of the stepped portion may be non-smooth. That is, the surfaces 128a-128i of the stepped portion may have a surface roughness (e.g., surface texture).

In the illustrated embodiment, the lid 100 is shown as a pre-assembled lid in which the pegs 110 are already coupled thereto. In the illustrated embodiment, the pegs 110 are integrally formed (e.g., via injection molding) with the lid 100. In other embodiments, the pegs 110 may be coupled to the lid 100 in other ways. In other embodiments, the lid 100 may be part of a kit including the lid 100 and a plurality of pegs 110 uncoupled to the lid 100. In such case, each of the pegs 110 may be coupled to the lid 100 by the operator using an adhesive (e.g., nitrocellulose nail varnish or the like) or any other suitable coupling method.

As will be discussed in greater detail below, the pegs 110 described above aid in better in situ imaging of biofilm.

### Experiment 1

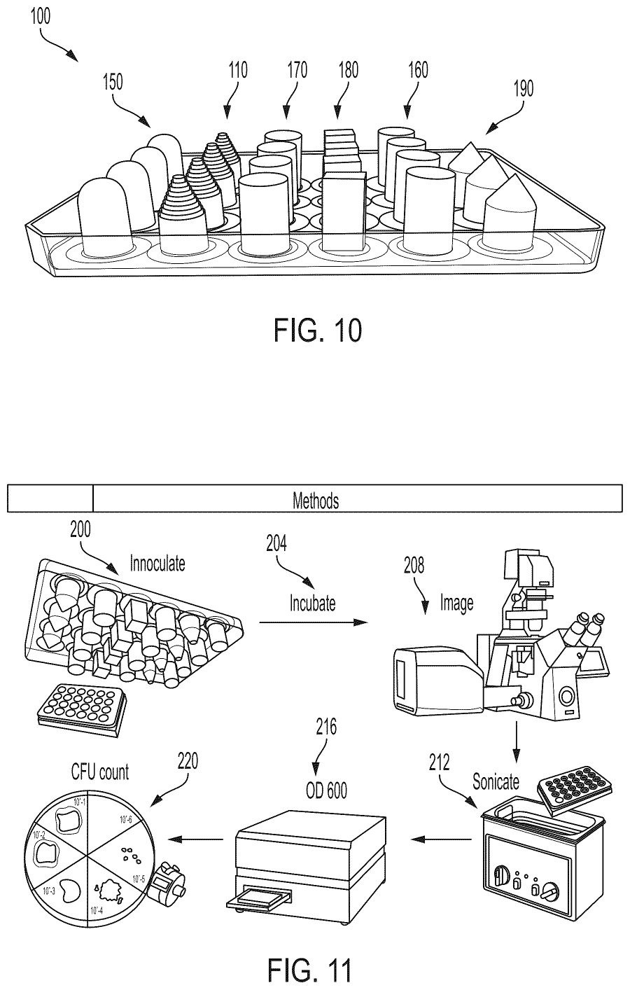

With respect to FIGS. 10-11, pegs 110, 150, 160, 170, 180, 190 having six different geometries were tested on the lid 100. In particular, the pegs 110, 150, 160, 170, 180, 190 were formed using 3D printing with durable resin. A hemisphere peg 150 (e.g., the original peg), the peg 110, a tall cylinder peg 160, a short cylinder peg 170, square peg 180, and a cone peg 190 were evaluated. The peg designs were compared based on ease and reproducibility of collecting image tiles and Z-stacks. With specific reference to FIG. 11, at step 200, the pegs 110, 150, 160, 170, 180, 190 were inoculated in a 24-well plate with media and incubated at step 204. At step 208, the pegs 110, 150, 160, 170, 180, 190 were washed and placed in PBS for imaging. The pegs 110, 150, 160, 170, 180, 190 were sonicated, at step 212, to remove attached biofilm, which was quantified using OD 600 reading at step 216 and a CFU count at step 220.

Peg designs were imaged by placing markers around the edge of the peg to define the desired area and z-positions were defined for the focus surface. This method decreased image set up time but did not work well with the angled pegs. On those pegs, z positions were far apart and would fail to capture the whole surface. This was less challenging with the mostly flat pegs where the difference between z positions was smaller. This challenge was minimized in the later antibiotic tests because tiles with z-stacks were used. Here, speed was sacrificed because the area being imaged was smaller.

The hemisphere and cone pegs 150, 190 were eliminated because it was challenging to define the surface of the pegs in order to image the angles and curves leading to discontinuous images. The edges of the square peg 180 made it easier to define the tile area but trapped bubbles reducing area coverage and reproducibility. The tall peg 160 also trapped bubbles. The short cylinder, tall cylinder, and square pegs 170, 160, 180 were slow to image due to their size, and the sides were not easily imaged. The peg 110 produced the best results because the lowest step 128h could be quickly and easily imaged and the levels between the steps 128a-128i allowed the formation and imaging of well-known biofilm morphologies that have not been obtained in other high throughput devices. Depending on the type of microscope, other levels 128a-128i may also be quickly and easily imaged. The peg 110, therefore, was validated against an antibiotic challenge of P. aeruginosa PA14.

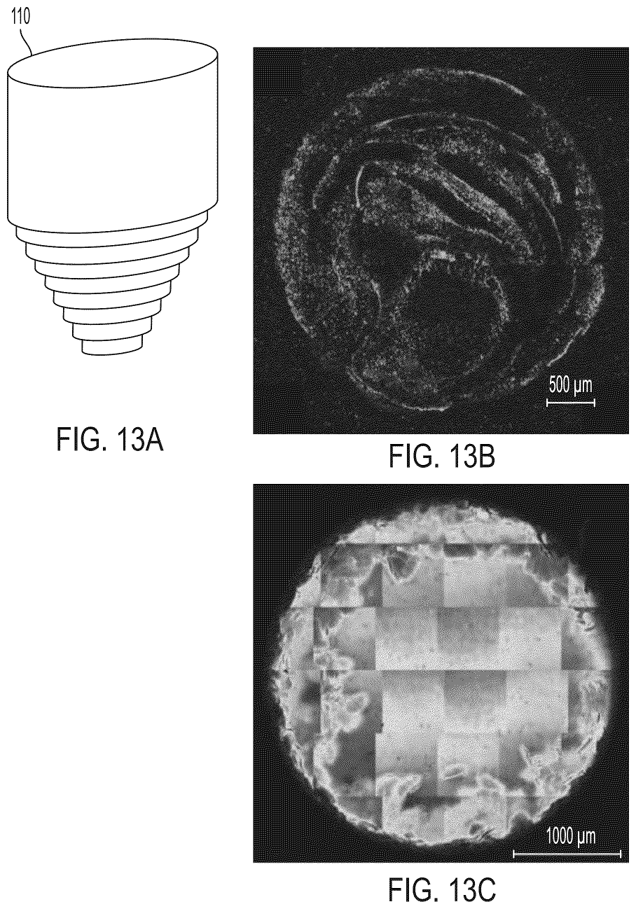

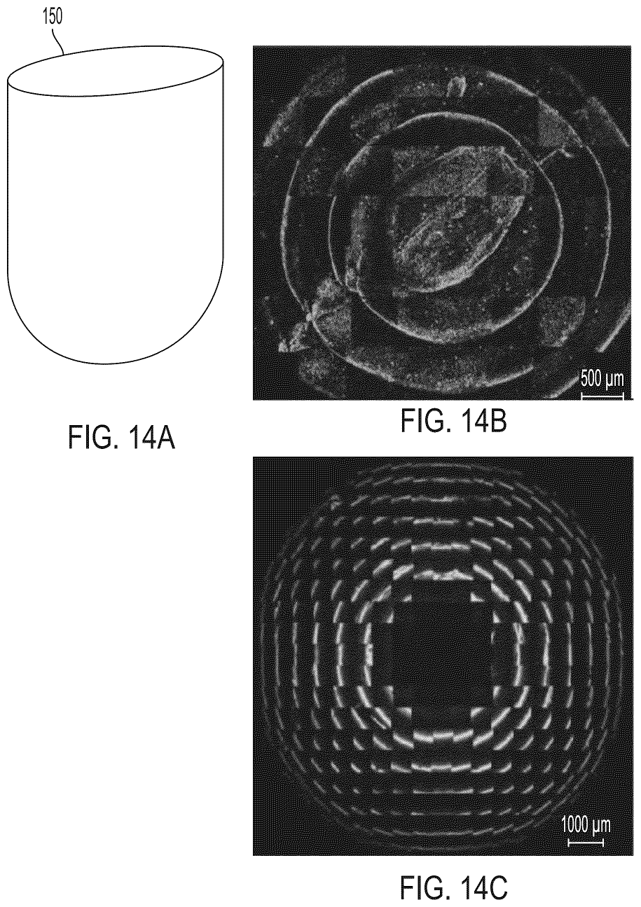

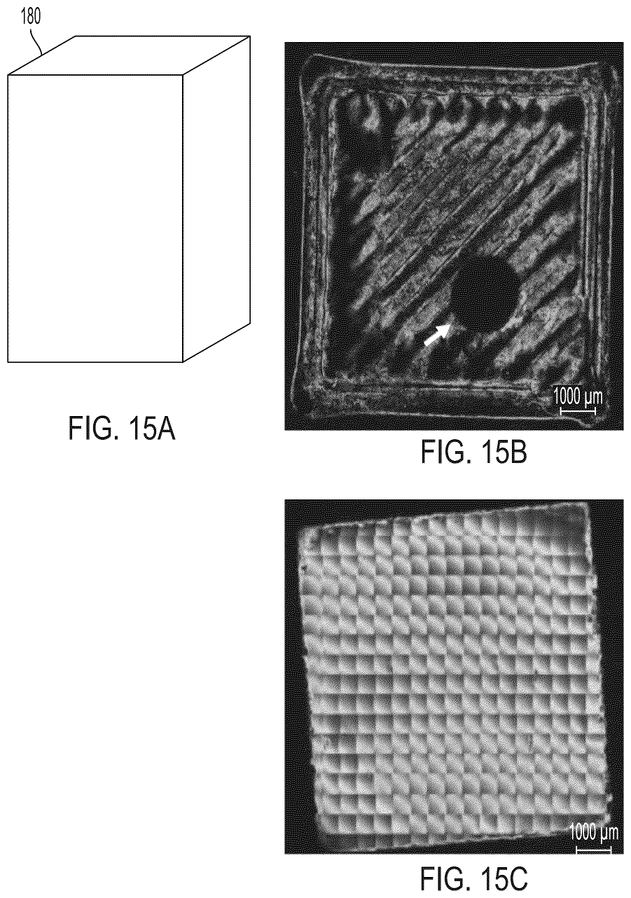

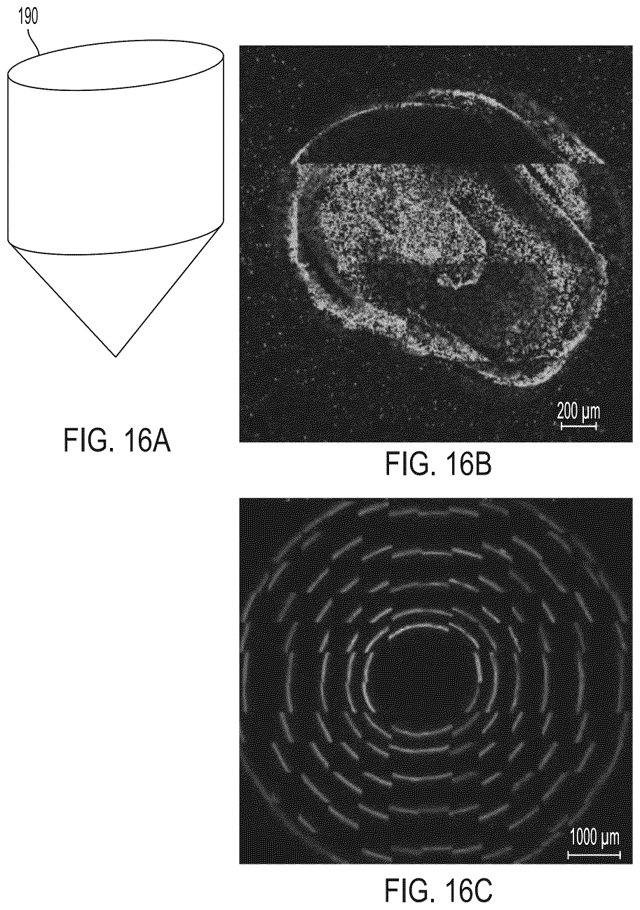

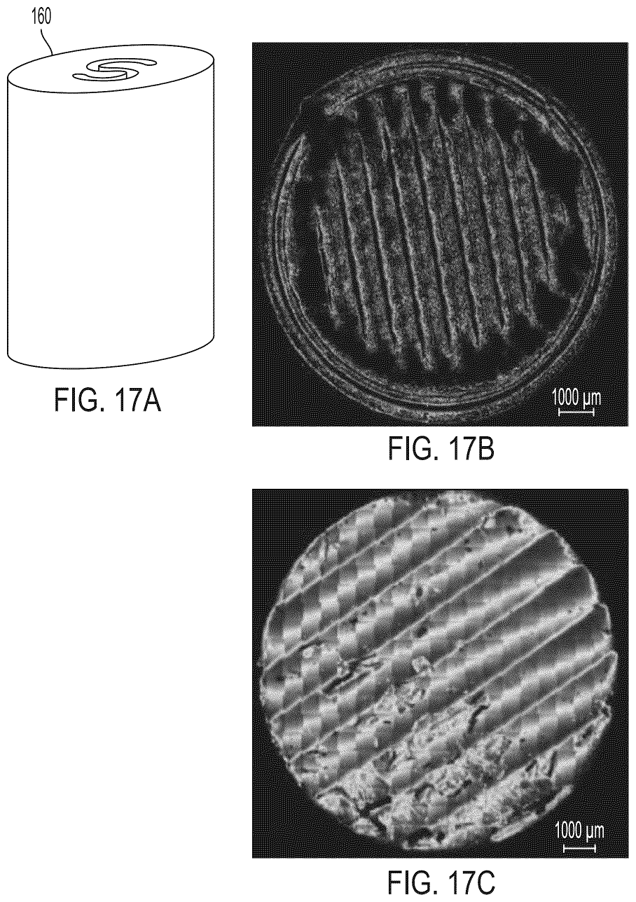

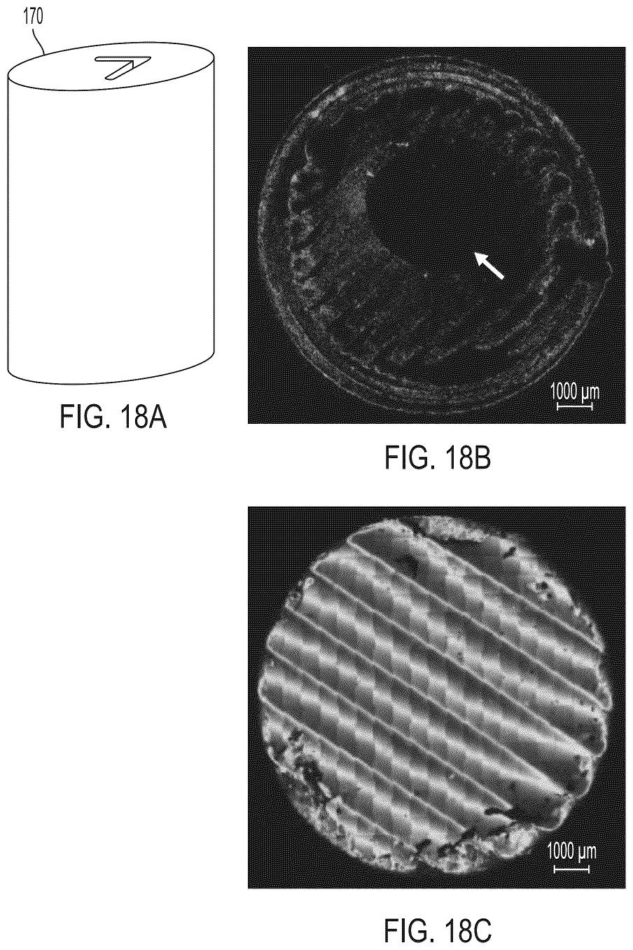

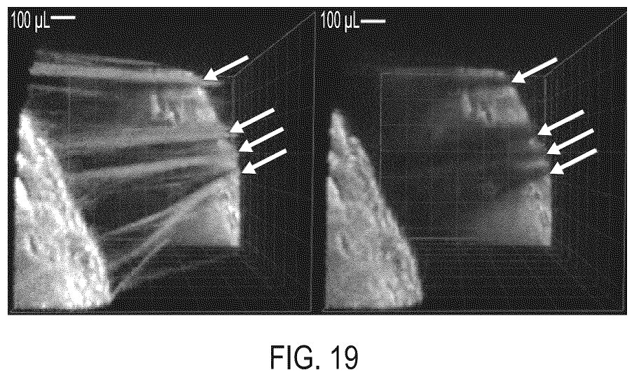

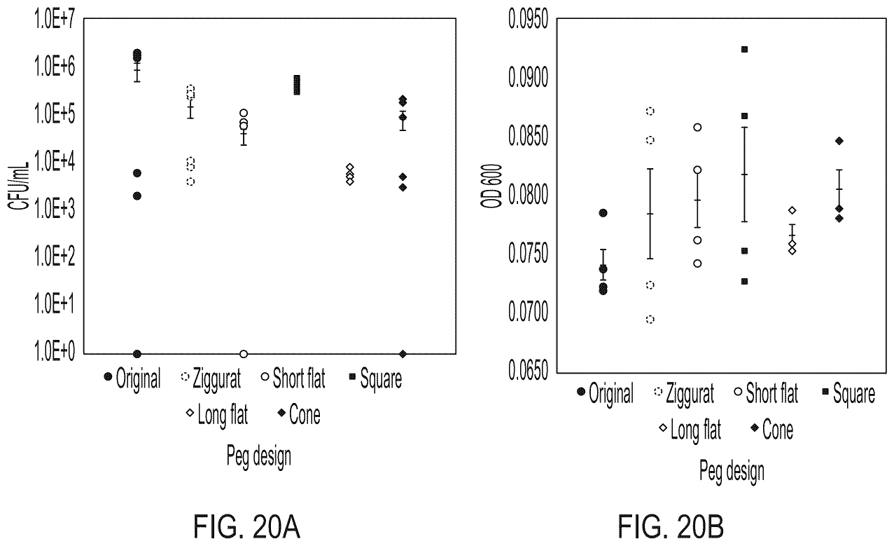

The images in FIGS. 12A, 13A, 14A, 15A, 16A, 17A, and 18A, represent E. coli 517-1 lambda pir constitutively expressing mOrange2 growing on either the commercially available MBEC assay or PLA pegs. The images in FIGS. 12B, 13B, 14B, 15B, 16B, 17B, and 18B are P. aeruginosa PA14 constitutively expressing GFP. These images were used to select the peg 110 for further testing. Paired with the confocal images are the 3D models of the peg designs. FIGS. 20A and 20B show a CFU count and OD 600 reading from the early design and testing of the alternative designs using PLA pegs. Many of the confocal images show discontinuous stitching due to above-noted challenges defining the surface, which was more pronounced in the angled pegs (e.g., hemisphere peg 150 and cone peg 190). This was addressed in the imaging for the antibiotic assay of the peg 110 by adding more z resolution to the tiles, which was feasible due to the smaller surface area. Moreover, with respect to FIG. 19, excessive biomass from biofilm streamers of the ziggurat peg causes a “shadow” to be cast on the autofluorescing disk. For orientation, in the left-hand corner is the second end 116 and the arrows are pointing to biofilm streamers attaching to the step 128h.

The surface roughness visible in FIGS. 12A-12B, 13A-13B, 14A-14B, 15A-15B, 16A-16B, and 17A-17B is an artifact of the 3D printing rapid manufacturing method. However, the material used in the final design has visibly reduced (not measured) surface roughness. Furthermore, it does not visually show in the final P. aeruginosa images relative to the E. coliimages due to their different levels of biofilm formation. However, surface roughness can be beneficial for initial biofilm development stages so introducing surface roughness may be valuable to this, microtiter assays, and the MBEC® assay.

The initial peg designs 110, 150, 160, 170, 180, 190 were workshopped using PLA. An empirical evaluation of resin materials which more closely resembled the plastics used in the standard MBEC® assay was performed. Resins were limited to those compatible with the Formlabs Form2 printer. The Clear Resin (RS-F2-GPCL-04) was not resistant to chemical exposure. The Durable Resin (RS-F2-DUCL-02) had high levels of autofluorescence. After consulting with Formlabs, final designs were produced using Tough 1500 (RS-F2-T015-01) as it could handle chemical exposure, had low autofluorescence, and was safe for humans to wear so was potentially biocompatible to bacteria.

### Experiment 2

With respect to FIGS. 1 and 4-9B, the peg 110 was tested against a modified version of the original protocol of Experiment 1. In situ confocal scanning fluorescence microscopy was performed, which resulted in additional quantitative information on the impact of antibiotics on biofilm streamers.

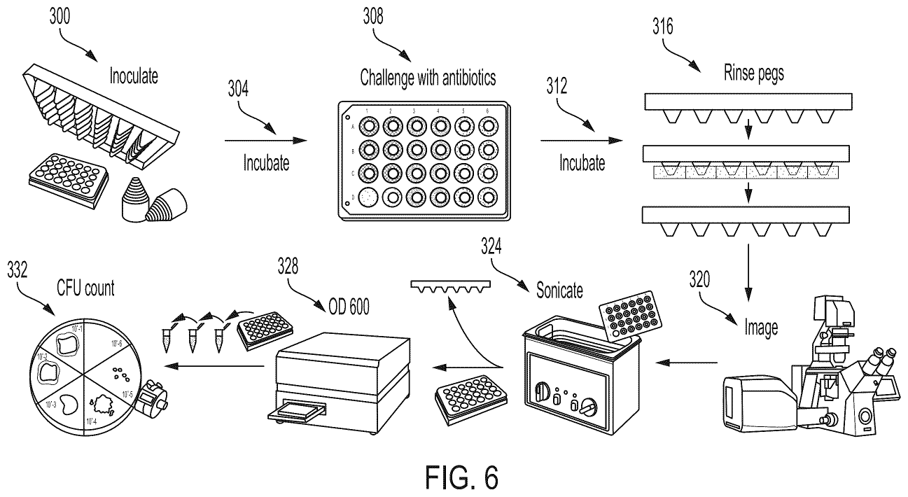

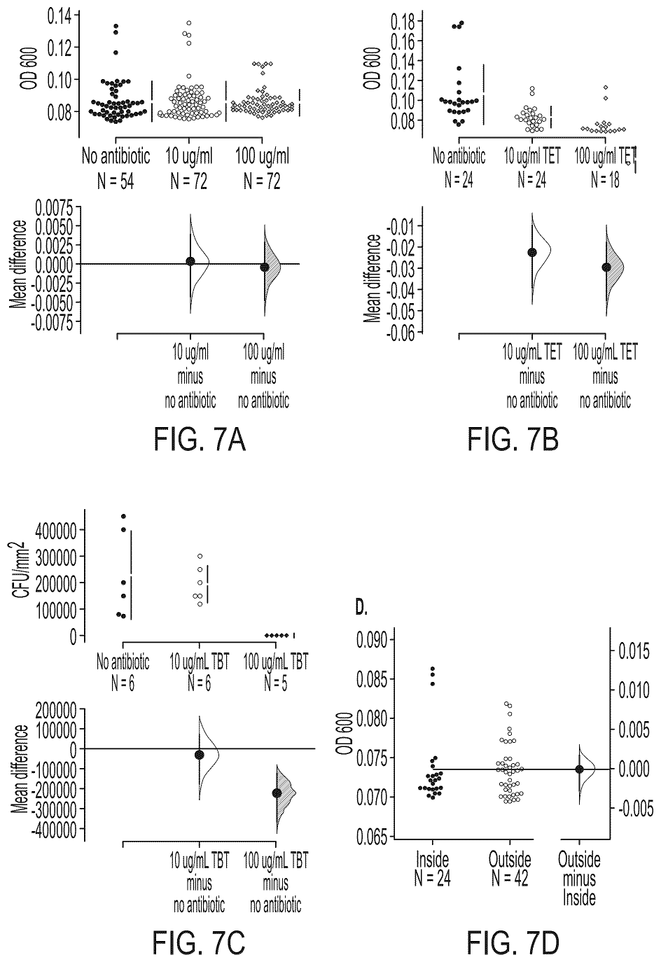

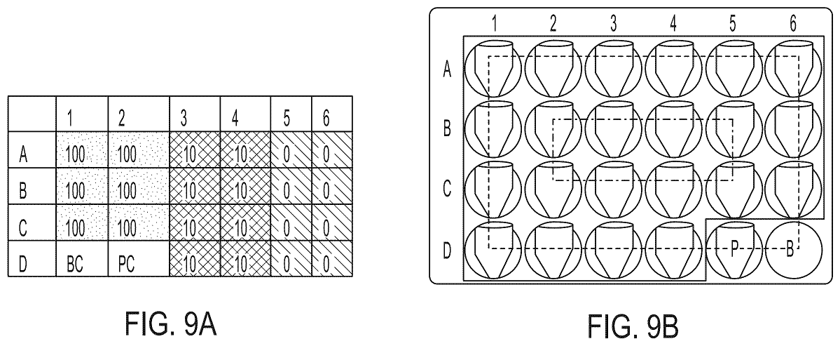

The applicability lid having pegs 110 with a ziggurat shape was evaluated to the relevant ATSM standard, E2799-22, modified workflow FIG. 6. Specifically, the pegs 110 were inoculated in a 24-well plate with media at step 300 and incubated at step 304. At step 308, the pegs 110 were then challenged with antibiotics and then incubated again at step 312. At step 316, the pegs were washed or rinsed and, at step 320, placed in PBS for imaging. The pegs 110 were sonicated, at step 324, to remove attached biofilm, which was quantified using OD 600 reading, at step 328, and a CFU count, at step 332. Importantly, the lid 100 could be handled in the same fashion as the commercially available peg lid. The pegs 110 were less rigidly attached to the lid 100 than the commercially available peg lid and could be broken off easily for a biofilm growth check, although due to the ring of biofilm at the air-medium interface typical of wild-type PA14, this could also be verified visually. Due to the design, it was also possible to image in situ. With respect to FIGS. 7A-7D, after imaging, OD 600 and CFU counts were performed to verify no loss of function between the lid 100 optimized for imaging and the commercially available peg lid. Specifically, the raw data and mean difference versus no antibiotics are shown for 100 μg/mL tetracycline, 10 μg/mL tetracycline on an OD 600 basis on the MBEC® Assay (FIG. 7A), the modified plate (FIG. 7B), and on a CFU/mm2 for PA14 (FIG. 7C). FIG. 7D shows equivalent biofilm test using OD 600 readings of biofilm recovered in PBS by sonication from the peg 110. PA14 was grown on pegs in TSB for 24 hours before recovery. Wells were categorized as “inside” (e.g., those on the dash-dot line) or “outside” (e.g., those on the dashed line) according to the layout in FIG. 9B. The mean differences was plotted using bootstrap sampling distributions and 95% confidence interval is indicated by the ends of the vertical error bars using EstimationStats.

Using tetracycline as the antibiotic challenge, 0 and 3-fold reduction in CFU on a per area basis at 10 and 100 μg/mL was observed. Relative to the area of the MBEC® Assay, 46.63 mm2 the area of this peg 110 presents a 6.5-fold increase to 302.1 mm2. Using OD600, a 0.02 and 0.03 mean reduction at 10 and 100 μg/mL respectively, was observed, which is similar to what was seen with the MBEC® Assay. These results agree with the literature on tetracycline against P. aeruginosa PAO1 biofilms with a similar intermediate concentration (0-8 μg/mL tetracycline) and strain MTCC 2488 with lower concentrations (0 and 2 μg/mL tetracycline). As noted above relative to FIG. 7D, an equivalent growth test in TSB with the peg lids 100 showing a negligible mean difference between the inner and outer pegs 110 was performed.

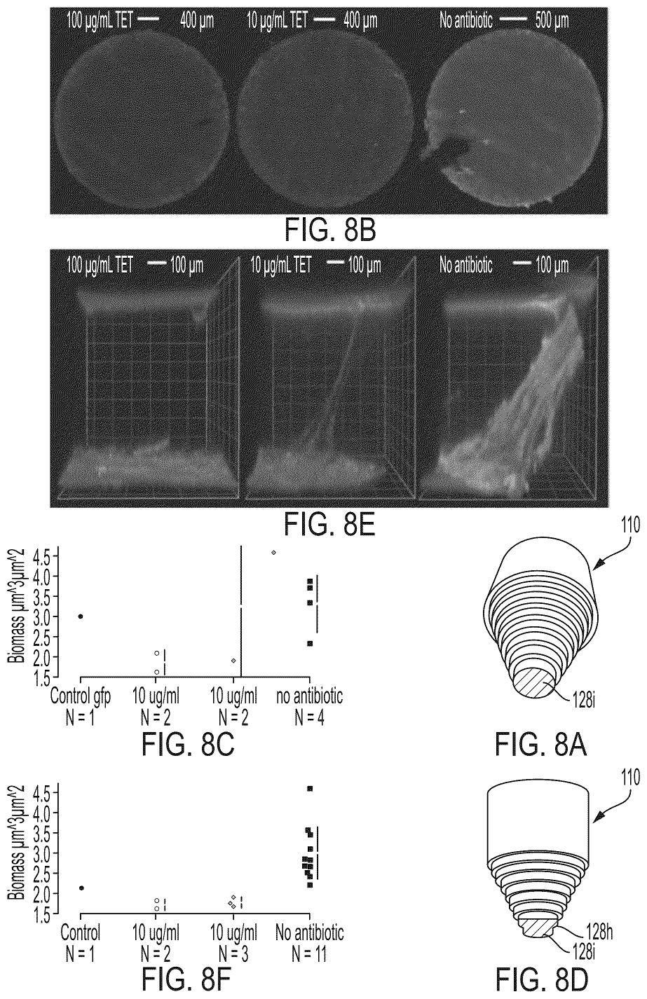

The intent of this peg 110 is to optimize for in situ confocal imaging. Two imaging techniques were applied to evaluate this. With respect to FIG. 8B, the surface 128i of the distal-most portion 128i of the peg 110 was captured using a tile and z-stack approach. The biomass formed on the edges of the peg 110 and, in the “no antibiotic” samples, could be thick enough to scatter the fluorescent light emission. FIG. 8B illustrates selected 3D tiles of the surface of the surface 128i of the peg 110 with an area of 8.042 mm2. This is known to leave imaging artifacts resembling “holes” in the images observed in FIG. 8B (e.g., “No antibiotic”). Selected Z-stacks of the space between the surface 128i and the step 128h are shown in FIG. 8E. Streamers, are often formed in this area. The space between steps 128a-128i formed biofilm streamers, as can be seen in FIG. 8E. The biofilms formed without antibiotics were robust and thick while the streamers formed under low levels of tetra-cycline were less frequent and thin. For example, in FIG. 8E, the streamer produced by PA14 in the presence of 10 μg/mL has an approximate midpoint diameter of 40.05±11.98 μm which was 12.96% of the no antibiotic streamer at 309.09±10.43 μm. With respect to FIGS. 8A and 8C, the surface biomass on the second end 116 analyzed using COMSTAT 2.1 was plotted using EstimationStats. With respect to FIGS. 8D and 8F, the biomass on the second step 128h of the step analyzed using COMSTAT 2.1 was plotted using EstimationStats. With respect to FIGS. 8C and 8F, similar to what was shown by the CFU count and OD 600 measurements, biomass (μm3/μm2) increased as antibiotic concentration decreased, although there was a low sample size.

This early-stage evaluation of a redesign of MBEC® assay was motivated by the need to add in situ imaging capability to microtiter assays of bacterial biofilms. While six geometries were considered, all but one (the peg 110) was rejected due to various troubleshooting issues. The final design was tested against the original protocol in addition to in situ microscopy. The peg 110 was validated against an antibiotic challenge of P. aeruginosaPA14. This alternative peg 110 was able to complete a modified ASTM 2799 protocol with the addition of CLSM. It was not only found that the original protocol could be repeated, but also that known complex biofilm morphologies could be observed and their response to antibiotic challenges quantified.

The peg 110, having the ziggurat geometry, provides more dynamic views of structures than a flat surface. We observed biofilm streamers in FIG. 8E for no antibiotic and 10 μg/mL of antibiotic. Biofilm streamers were first reported in situ by Stoodley and Lewandowski under turbulent flow conditions. Biofilm streamers are biofilms that are high-aspect ratio aggerates attached to at least one surface extending into a flow field. They are best measured using in situ microscopy methods and can also be quantified using pressure transducers as they produce oscillatory changes in pressure. Biofilm streamers have since been replicated under laminar flow conditions and implicated in pressure loss in mechanical systems clogging of porous media, blood vessels, and heart valves. Effects of antibiotics on dispersion and clogging have been measured, showing limited effect, however effects on the structure and thickness of the streamer itself were not reported. Model systems for studying streamers have been micro or millifluidic devices that could be mounted onto microscopes as most studies consider streamers as functions of the fluid interaction with obstructing geometries. Specifically, biofilm streamers have been noted to form on secondary vortices where biofilms form on free surfaces. Here, a quantifiable reduction in thickness was observed under antibiotic challenge. While the 24-well plate is in laminar flow at 100 rpm, it is reasonable, but remains to be shown if there are secondary vortices forming at the right-angle of the two steps where the streamer formed. Since bulk material strength is proportional to material thickness, the ability to observe this weakening is useful information gained by in situ microscopy. These streamers have not been described in work utilizing the MBEC® system or microtiter assays, though it may be reasonable to assume that streamers could form between the apex of the peg 110 and well if imaged in situ. As has been the case in other in situ imaging studies of microtiter plates, imaging and biomass computation takes excessive time, which may limit usefulness of this and other implementations of imaging microtiter assays. Subsequently, the biomass measurements were not repeated enough to report statistical significance.

Selection of peg materials impacted sterilization and imaging quality. For a reusable device, the material must be resistant to UV and chemicals used in cleaning such as sodium hypochlorite and isopropyl alcohol, which eliminates some resins used in stereolithography. For high image quality, the material must also be minimally auto-fluorescence to prevent complications during biofilm quantification. With the advent of additive manufacturing, other 3D printers could leverage other plastics, glass, metals, and/or 3D bioprinters could produce biological materials to perform similar studies.

The peg 110 was compared to microtiter and the MBEC® assay. Relative to the MBEC® assay, microscopy can be performed in situ allowing image collection from multiple pegs 110 without reducing the number of samples for the OD 600 and CFU count. Furthermore, the imaged pegs 110 are not limited to the outer edges of the plate as in the MBEC® assay. Additionally, relative to the MBEC® assay, the pegs 110 did not need to be extensively handled, which reduced the risk of contamination or disruption of the biofilm. The peg 110 compared to the microplate assay has a longer working distance. However, the outer wells of microtiter plates are known to suffer from “edge effects” as a result of uneven evaporation and temperature distributions, so imaging and other results from the interior is preferred. Furthermore, the peg 110 allows for biofilm morphologies to be imaged including streamers.

The MBEC® assay was an improvement of the microtiter plate assay recognizing that studies of bacterial biofilm growth and disruption required a high-throughput assay collecting more representative data. However, the MBEC® assay reduced the capability for in situ imaging that has also become a feature of microtiter assays and biofilm studies. Here, the peg 110 maintains existing MBEC® protocols while adding in situ CLSM imaging. The peg 110 geometry also allowed for the formation of biofilm streamers that opens possibilities for medium-throughput screening of biofilm fluid-structure antibiotic interactions. While the device has only been examined at a single time point to show the fidelity with existing protocols, the peg 110 enables in situ observations of dynamic biofilm responses to antibiotics. Furthermore, it could enable examination biofilm streamer response to the addition of antimicrobials or changes in nutrients. This peg 110 merges the successful features of the microtiter plate assay and the MBEC® assay to build an easy-to-implement and flexible assay for examining biofilms.

### Materials and Methods

### Peg-lid Production

The six distinct modified pegs geometries (FIG. 10) were designed using Autodesk Fusion 360 and 3D printed with Durable Resin (For-mlabs, USA), for the initial designs 110, 150, 160, 170, 180, 190 (FIG. 10), or Tough 1500 Resin (Formlabs, USA), for the final design 110 (FIG. 4). 3D printing was performed using a Formlabs Form 2 low-force stereolithography 3D printer (see discussion in SI on resin choice). Prior to use, pegs 110, 150, 160, 170, 180, 190 were soaked in 1-2% solution of Citranox detergent (VWR International, USA), rinsed with deionized water, and air dried. Pegs 110, 150, 160, 170, 180, 190 were fixed to a sterile 24-well plate lid using a small drop of clear nitrocellulose nail varnish and sterilized with a UV lamp. After use, pegs 110, 150, 160, 170, 180, 190 were soaked in a 0.5-0.7% solution of sodium hypochlorite, removed from the plate lid 100, vortexed in acetone to remove remaining nail varnish, and cleaned for reuse.

### Bacterial Strain and Growth Condition

Experiments were conducted using Pseudomonas aeruginosa PA14, which constitutively expressed GFP. Cultures were grown over-night in tryptic soy broth (VWR International, USA) at 37° C. and 150 rpm. 10 μL of the overnight culture was used to inoculate 50 mL of fresh TSB. The growth plate (24 well, VWR International, USA) was prepared by dispensing 8 mL of broth per well, adding the peg lid 100, and incubating for 24 h at 37° C. and 100 rpm. The antibiotic challenge plate was pre-pared (layout in FIG. 9A) and the peg lid 100 was transferred from the growth plate and incubated for 24 h at 37° C. and 100 rpm.

Transfers between media and rinse plates were accomplished by lifting the peg lid 100, allowing excess liquid to drip off, and gently placing the lid 100 in the new plate. Before imaging, the peg lid 100 was rinsed in sterile deionized water and placed in phosphate-buffered saline (PBS). One of the challenges with microtiter assays is uniform growth across wells, potentially due to uneven heat transfer and evaporation rates. An equivalent growth test in TSB with the peg lids 100 was performed using the layout in FIG. 9B. The efficacy of removal from the surface by sonication as not tested, however the resultant OD600 readings for P. aeruginosabetween this and the MBEC® assay were similar

ASTM standard 2799-22 was followed with five deviations to fit the experiment and modified design. The first deviation was that serial dilutions of the inoculum were not performed. The second deviation was that a biofilm growth check was not performed. The third deviation was that the challenge plate layout was altered to fit a 24-well plate. The fourth deviation was that the biofilm growth time was increased from 16-18 h to 24 h prior to the antibiotic challenge. The final deviation was the peg lid was transferred into a recovery plate for neutralization by dilution as opposed to neutralizer since antibiotics were being tested.

### Standardized Methods

After imaging, the peg lid 100 suspended in PBS was sonicated on high for 30±5 min using a Branson ultrasonic bath (Branson Ultrasonics, USA). The peg lid 100 was removed and replaced with a standard lid before taking an OD 600 reading of PBS recovery plate using a SpectraMax i3x plate reader (Molecular Devices, USA). A serial dilution was then performed on a selected row and spot-plated onto TSA for enumeration of CFU attached to the peg 110, 150, 160, 170, 180, 190. A simplified workflow diagram of the described procedure is shown in FIG. 6.

### Microscopy Methods

Pegs 110, 150, 160, 170, 180, 190 were imaged in PBS with an inverted Zeiss LSM 900 (Zeiss, Germany) using a 488 nm laser for excitation and detection wavelengths of 410-546 nm (green) for GFP and 590-700 nm (red) for identifying autofluorescence. Imaging was conducted using a 10× objective to compensate for the increased working distance. Images were taken by stitching square tiles (585×585 μm, 469×469 pixels) of the peg 110 surface with or without Z-stacks. The steps on the peg 110, the final design selected, were also imaged using Z-stacks. Biomass quantification of antibiotic plate images was performed using Comstat2 v2.1 as an ImageJ plugin.

### Statistical Methods

Estimation statistics were used to quantify the magnitude of the effect of each concentration of antibiotic challenge relative to the no antibiotic control. CFU counts were all performed using 2 wells per condition and 3 replicate plates per well. OD 600 readings were performed using all wells per condition with 3 replicates per well. Biomass quantification was performed using available confocal images. All data is presented and analyzed using a Cummings estimation plot produced using EstimationStats. This displays both the raw data (upper axis) and the mean difference for 2 comparisons against the shared control (lower axis) plotted as bootstrap sampling distributions with the ends of the vertical error bars indicating a 95% confidence interval. When the sample size was too low (specifically the analyzed images, see FIGS. 7A-7D), mean difference was not included.

Various features and advantages are set forth in the following claims.

What is claimed is:

1. A lid for an assay comprising:
a peg coupled to and extending from the lid, the peg including
a first end coupled to the lid,
a second end opposite the first end,
a longitudinal axis extending between the first end and the second end,
a first portion extending from the first end towards the second end, the first portion having a first surface that extends along the longitudinal axis and that has a first outer dimension and a second surface that extends inwardly from the first surface towards the longitudinal axis;
a second portion positioned between the first portion and the second end, the second portion having a third surface that extends along the longitudinal axis and that has a second outer dimension that is less than the first outer dimension and a fourth surface that extends inwardly from the third surface towards the longitudinal axis; and
a third portion extending from the second end towards the first end, the third portion having a fifth surface that extends along the longitudinal axis and that has a third outer dimension that is less than the second outer dimension and a sixth surface that extends inwardly from the fifth surface towards the longitudinal axis.

2. The lid of claim 1, further comprising a fourth portion extending between the first portion and the second portion, the fourth portion having a seventh surface that extends along the longitudinal axis and that has a fourth outer dimension that is less than the first outer dimension and greater than the second outer dimension and an eighth surface that extends inwardly from the seventh surface towards the longitudinal axis.

3. The lid of claim 2, wherein the first portion defines a cylindrical shape and the second portion, the third portion, and the fourth portion collectively define a ziggurat shape.

4. The lid of claim 1, wherein the second surface, the fourth surface, and the sixth surface are substantially parallel to one another.

5. The lid of claim 1, wherein the first portion, the second portion, and the third portion have generally circular cross-sections.

6. The lid of claim 1, wherein the first surface and the second surface are transverse to one another, wherein the third surface and the fourth surface are transverse to one another, and wherein the fifth surface and the sixth surface are transverse to one another.

7. The lid of claim 1, wherein at least the third portion and the fourth surface have a non-smooth surface.

8. A lid for an assay comprising:
a peg coupled to the lid, the peg including
a first end coupled to the lid,
a second end opposite the first end,
a longitudinal axis that extends between the first end and the second end,
a first portion extending from the first end towards the second end and having a first outer dimension,
a second portion extending from the second end towards the first end and having a second outer dimension, and
a third portion positioned between the first portion and the second portion, the third portion having a third outer dimension that is smaller than the first outer dimension and greater than the second outer dimension, a surface of the third portion defining a step between the first end and the second end.

9. The lid of claim 8, wherein each of the first portion, the second portion, and the third portion is substantially cylindrical.

10. The lid of claim 8, wherein each of the first portion, the second portion, and the third portion are concentric with one another.

11. The lid of claim 8, wherein the surface of the third portion is transverse to the longitudinal axis.

12. The lid of claim 8, wherein at least the second portion and the step have a non-smooth surface.

13. The lid of claim 8, wherein a step is a first step, and further comprising a fourth portion positioned between the first portion and the third portion, the fourth portion having a fourth outer dimension that is smaller than the first outer dimension and greater than the third outer dimension, a surface of the fourth portion defining a second step between the first end and the second end.

14. The lid of claim 13, wherein the surface of the third portion and the surface fourth portion are generally transverse to the longitudinal axis.

15. A device to conduct an assay, the device comprising:
a base; and
a lid that is couplable to the base, the lid including
an inner wall; and
a plurality of pegs coupled to inner wall, each of the pegs including
a first end coupled to the wall,
a second end opposite the first end,
a longitudinal axis extending between the first wall and the second wall,
a non-stepped portion extending from the first end towards the second end, and
a stepped portion extending from the second end to the non-stepped portion,
wherein when the lid is coupled to the base, the plurality of pegs is positioned within the base.

16. The device of claim 15, wherein the stepped portion includes a plurality of steps.

17. The device of claim 16, wherein each of the plurality of steps has a surface that is transverse to the longitudinal axis.

18. The device of claim 16, wherein a first step of the plurality of steps is positioned adjacent the second end and a second step of the plurality of steps is positioned between the first step and the non-stepped portion, the first step having a first outer dimension and the second step having a second outer dimension that is greater than the first outer dimension.

19. The device of claim 18, wherein the non-stepped portion defines a third outer dimension that is greater than the second outer dimension, and wherein the first step, the second step, and the non-stepped portion are concentric with one another.

20. The device of claim 15, wherein the stepped portion has a non-smooth surface.
